(19) United States
(12) Patent Application Publication
(10) Pub. No.: US 2024/0147989 A1
(43) Pub. Date: May 9, 2024

(54) FLYING INSECT EXTERMINATION SPRAY

(71) Applicant: Kao Corporation, Chuo-ku, Tokyo (JP)

(72) Inventors: Aya NAMBA, Sumida-ku, Tokyo (JP); Toshiaki IIDA, Sumida-ku, Tokyo (JP); Masahiro SUZUKI, Wakayama-shi, Wakayama (JP); Kazuma SAITO, Haga-gun, Tochigi (JP); Ryota KOIZUMI, Sumida-ku, Tokyo (JP)

(73) Assignee: Kao Corporation, Chuo-ku, Tokyo (JP)

(21) Appl. No.: 18/281,036

(22) PCT Filed: Mar. 8, 2022
(86) PCT No.: PCT/JP2022/009844

§ 371 Date: Sep. 8, 2023

(30) Foreign Application Priority Data
Mar. 11, 2021 (JP) 2021-039552

(51) Int. Cl. A01N 25/06; A01N 31/14; A01N 33/12; A01N 41/04; A01P 7/04

(52) U.S. Cl. CPC A01N 25/06; A01N 31/14; A01N 33/12; A01N 41/04; A01P 7/04

(57) ABSTRACT

The present invention relates to a flying pest exterminating spray, including a trigger spray type spray container and a flying pest exterminating composition filled in the trigger spray type spray container, in which the flying pest exterminating composition contains a surfactant (A) and water, and in the volume particle size distribution of a sprayed product of the flying pest exterminating spray measured at a position of 30 cm in terms of a horizontal distance from an injection port of the trigger spray type spray container, the proportion of the sprayed product having a particle diameter of 310 μm or less is 70% by volume or more and 95% volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

### FIELD OF THE INVENTION

The present invention relates to a flying pest exterminating spray and a flying pest exterminating composition.

### BACKGROUND OF THE INVENTION

Pests, for example, flying pests, such as mosquitoes and flies, carry pathogens to animals, such as humans, and are factors that cause infectious diseases and dermatitis. In particular, some mosquitoes are hygienically very harmful insects because they carry pathogens, such as dengue fever, Zika fever, yellow fever, encephalitis, and malaria.

Conventionally, in order to protect themselves from such flying pests, a method of spraying an insecticide, a method of applying a pest repellent onto the skin surface, and so on have been widely used.

However, in insecticidal components contained in insecticides and pest repellent components contained in pest repellents, there is a concern to safety for a human body. In particular, it is desired to apply a highly safe insecticide or pest repellent to young children who always get bitten by mosquitoes.

In addition, conventionally it has been studied to prevent insect bite and sting mainly outdoors. However, according to recent research, it has become clear that the frequency of mosquito bite even indoors is equal to or higher than that outdoors. Then, a proposal for defending oneself from flying pests even indoors is desired.

With respect to a method of capturing and exterminating flying pests without using an insecticidal component, for example, JP2004-180635A (PTL 1) discloses a method of capturing flying insects, such as flies, by spraying ethyl alcohol or a liquid containing ethyl alcohol on the flying insects to prevent them from flying.

JP2012-97004A (PTL 2) discloses that a pest exterminator and a pest extermination preparation, each of which is an aqueous liquid containing a (meth)acrylic acid alkyl ester copolymer having film formability and a surfactant, exhibit a pest extermination effect even without containing an insecticidal component.

### SUMMARY OF THE INVENTION

The present invention relates to a flying pest exterminating spray, including a trigger spray type spray container and a flying pest exterminating composition filled in the trigger spray type spray container, in which the flying pest exterminating composition contains a surfactant (A) and water, and in the volume particle size distribution of a sprayed product of the flying pest exterminating spray measured at a position of 30 cm in terms of a horizontal distance from an injection port of the trigger spray type spray container, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

### DETAILED DESCRIPTION OF THE INVENTION

PTL 1 describes that ethyl alcohol itself or, for example, a liquid prepared by diluting 70% by weight of ethyl alcohol with 30% by weight of water is sprayed on flying insects. However, from the viewpoint of environmental safety, it may not be said that the method of spraying a liquid containing a large quantity of ethyl alcohol that is a combustible organic solvent is a preferred method.

The pest exterminator of PTL 2 is one which by containing the (meth)acrylic acid alkyl ester copolymer having film formability, lowers flexibility of alae of a flying pest during spraying on the flying pest, loses the flying ability, or forms a film capable of blocking the spiracles or trachea to suffocate the pest, thereby exhibiting an effect for exterminating the pest. However, in view of the fact the pest exterminator of the type of spraying on flying pests is required to be adjusted to a viscosity suitable for spraying, the addition amount of a polymer that is an active ingredient as the pest exterminator is substantially restricted. In addition, in order to enhance the extermination effect, the pest exterminator of the type of spraying on flying pests is also required to have the ability to efficiently reach flying pests even when sprayed on flying pests from a place with a certain distance or more. The details of such a performance are not studied in PTLs 1 and 2.

The present invention relates to a flying pest exterminating spray, which has high straightness when a composition is sprayed from a spray, can allow a flying pest exterminating composition to efficiently reach flying pests, and can improve the extermination effect.

Further, the present invention relates to a flying pest exterminating composition, which is used by spraying on flying pests, has high straightness when the composition is sprayed from a spray, can efficiently reach flying pests, and can improve the extermination effect.

The present inventors have found that by setting the volume particle size distribution of a sprayed flying pest exterminating composition (hereinafter, also referred to as a “sprayed product”) to a specific distribution, the amount of the sprayed product reached when sprayed on flying pests can be increased, the composition can efficiently reach flying pests, and the extermination effect of flying pests can be improved.

That is, the present invention relates to the following [1] and [2].
[1] A flying pest exterminating spray, including a trigger spray type spray container and a flying pest exterminating composition filled in the trigger spray type spray container, in which the flying pest exterminating composition contains a surfactant (A) and water, and in the volume particle size distribution of a sprayed product of the flying pest exterminating spray measured at a position of 30 cm in terms of a horizontal distance from an injection port of the trigger spray type spray container, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.
[2] A flying pest exterminating composition which is used by spraying on flying pests, containing a surfactant (A) and water, in the volume particle size distribution of a sprayed product of the flying pest exterminating composition, measured at a position of 30 cm in terms of a horizontal distance from an injection port of a spray container filled with the flying pest exterminating composition, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

According to the present invention, it is possible to provide a flying pest exterminating spray, which has high straightness when a composition is sprayed from a spray, can allow a flying pest exterminating composition to efficiently reach flying pests, and can improve the extermination effect.

Further, according to the present invention, it is possible to provide a flying pest exterminating composition, which is used by spraying on flying pests, has high straightness when the composition is sprayed from a spray, can efficiently reach flying pests, and can improve the extermination effect.

### BRIEF DESCRIPTION OF THE DRAWING

FIG. 1 is a diagram for explaining microbubbles, and illustrates a photograph of a sprayed product at a position of 30 cm in terms of a horizontal distance from an injection port of a spray container, in which (a) shows sprayed products of Example 1, and (b) shows sprayed products of Comparative Example 3.

### [Flying Pest Exterminating Spray]

The flying pest exterminating spray of the present invention is a flying pest exterminating spray, including a trigger spray type spray container and a flying pest exterminating composition filled in the trigger spray type spray container, in which the flying pest exterminating composition contains a surfactant (A) (hereinafter, also referred to as a “component (A)”) and water, and in the volume particle size distribution of a sprayed product of the flying pest exterminating spray measured at a position of 30 cm in terms of a horizontal distance from an injection port of the trigger spray type spray container, the proportion of the sprayed product having a particle diameter of 310 μm or less (hereinafter, also referred to as a “small-particle diameter sprayed product”) is 70% by volume or more and 95% by volume or less, the proportion of the sprayed product having a particle diameter of 354 μm or more and 773 μm or less (hereinafter, also referred to as a “medium-particle diameter sprayed product”) is 0.05% by volume or more, and the proportion of the sprayed product having a particle diameter of 1483 μm or more and 1926 μm or less (hereinafter, also referred to as a “large-particle diameter sprayed product”) is 4.90% by volume or less.

Here, the spraying from the injection port of the trigger spray type spray container can be performed by pulling with a full stroke over 0.35 to 0.45 seconds at a substantially constant pressure so that the spraying direction from the injection port of the spray container becomes horizontal with respect to the ground.

The flying pest exterminating spray of the present invention can have high straightness when a composition is sprayed from a spray, can allow a flying pest exterminating composition to efficiently reach flying pests, and can improve the extermination effect.

Further, the flying pest exterminating spray of the present invention has a function of reducing a flying ability of flying pests by bringing a flying pest exterminating composition into contact with alae of a flying pest, and exhibits an extermination effect of flying pests by making the composition harmless by an action mechanism such as suppressing the flying of the flying pest or dropping the flying pest flying or landing on a wall or the like onto the ground.

In addition, in the present invention, reducing the flying ability of flying pests means that the flying pest becomes unable to fly. In addition, in the present invention, exterminating flying pests refers to rendering flying pests harmless to animals, such as humans, by an action mechanism such as suppressing the flying of the flying pest, shooting down a flying pest during flying to drop on the ground, or dropping a flying pest landing on a wall or the like on the ground.

In the present invention, the “flying pest” refers to a pest that approaches an animal, such as a human, while flying and suck blood from the skin of the animal, a pest that mediates pathogenic bacteria or the like while flying even without sucking blood, and a pest in which its own flying gives a feeling of displeasure to a human.

Specific examples of the flying pest include mosquitoes, such as Anopheles sinensis, Culex pipiens pallens, Culex tritaeniorhynchus, Aedes aegypti, Culex pipiens molestus, Aedes albopictus, Aedes togoi, Anopheles gambiae, and Anopheles stephensi; chironomidae, such as Chironomus yoshimatsui and Propsilocerus akamusi; black flies, such as Twinnia japonensis, Prosimulium yezoense, and Odagmia aokii; flies, such as Musca domestica, Muscina stabulans, Fannia canicularis, Calliphoridae, Sarcophagidae, Delia platura, Delia antiqua, fruit flies, fruit vinegar flies, moth flies, tsetse flies, and Stomoxys calcitrans; horseflies, such as Tabanus stygius, Tabanus trigonus, Chrysops suavis, and Haematopota pluvialis; biting midges, such as Leptoconops nipponensis, Culicoides sumatrae, and Culicoides arakawae; and bees, such as Vespa simillima xanthoptera, Polistes jokahamae, and honeybees.

The flying pest exterminating spray of the present invention exhibits an excellent extermination effect particularly against mosquitoes among them.

The flying pest exterminating spray of the present invention is used by spraying the composition of the present invention as a sprayed product having the above-described volume particle size distribution at a position of 30 cm in terms of a horizontal distance from an injection port of a trigger spray type spray container. The foregoing volume particle size distribution means a volume particle size distribution of a sprayed product of the flying pest exterminating spray of the present invention sprayed using a spray container. Specifically, the volume particle size distribution of the foregoing sprayed product is a value measured using a Spraytec laser diffraction system (manufactured by Malvern Panalytical Instrument, Model No. STP5921, equipped with a 750 mm lens manufactured by the same company) by the laser diffraction method with respect to the sprayed product at a position of 30 cm in terms of a horizontal distance from an injection port of a spray container in which the composition of the present invention is filled and discharged, and specifically it can be measured by a method described in Examples. When the sprayed product having the above-described volume particle size distribution at a position of 30 cm in terms of a horizontal distance from an injection port of a spray container is applied to the flying pests, the flying pests can be efficiently exterminated in practical use.

The reason why the effects of the present invention can be obtained is presumed as follows.

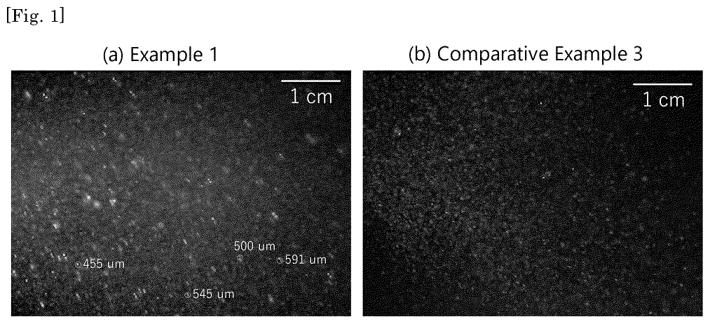

In the present invention, it is considered that the small-particle diameter sprayed product and the large-particle diameter sprayed product are droplets (hereinafter, also referred to as small-particle diameter droplets and large-particle diameter droplets, respectively), whereas the medium-particle diameter sprayed product is bubbles (hereinafter, also referred to as microbubbles). That is, both the outside and the inside of the droplet are composed of the foregoing composition of the present invention, whereas the outer surface of the bubble is composed of the composition and the inside is hollow. Here, FIG. 1 is a diagram for explaining microbubbles, and illustrates a photograph of a sprayed product at a position of 30 cm in terms of a horizontal distance from an injection port of a spray container, in which (a) shows sprayed products of Example 1, and (b) shows sprayed products of Comparative Example 3. As shown in FIG. 1(a), in the sprayed product of the flying pest exterminating spray of the present invention, microbubbles are observed.

At a position of 30 cm in terms of a horizontal distance from the injection port of the spray container, the sprayed product having the above volume particle size distribution contains a certain amount of light microbubbles because the inside is hollow, but the content of heavy large particle diameter droplets in which the contents are clogged is small, so that the balance of forces such as gravity and buoyancy applied to the sprayed product in the air is optimized. As a result, it is considered that the straightness of the sprayed product is increased, and the sprayed product containing microbubbles can be made to reach farther.

In addition, the composition of the present invention is considered to be excellent in the action of wetting the body of a flying pest by containing the surfactant (A). Both the surfactant (A) and water contained in the composition of the present invention are excellent in safety for the human body and the environment.

From the above, it is considered that, at a position of 30 cm in terms of a horizontal distance from the injection port of the spray container, the proportion of the small-particle diameter sprayed product is 70% by volume or more and 95% by volume or less, the proportion of the microbubbles is 0.05% by volume or more, and the proportion of the large-particle diameter droplets is 4.90% by volume or less, so that when the composition is sprayed on flying pests, the amount of the sprayed product reaching the flying pests increases, and the composition can efficiently reach the flying pests, and further, since the composition contains the surfactant (A), the composition exterminates flying pests by the action of wetting the alae of flying pests and reducing their flying ability, and thus, the above-mentioned extermination effect of flying pests can be improved.

That is, in the present invention, the flying pest exterminating composition containing the surfactant (A) is sprayed to the flying pests in a state of having the above-mentioned predetermined volume particle size distribution, whereby the flying pest exterminating composition efficiently reaches the flying pests, wets the alae of the flying pests, and exterminates the flying pests by the action of reducing the flying ability. For example, when the flying pest exterminating composition is sprayed on flying pests during flying, the flying pests drop owing to wetting of alae thereof and are alive but cannot fly, and are rendered harmless to humans. Therefore, the flying pest exterminating composition of the present invention is, for example, distinguished from a conventional insecticide containing an insecticidal component.

In the light of the above, the flying pest exterminating composition of the present invention is one using the surfactant (A) capable of wetting alae of a flying pest as an active ingredient for flying pest extermination and can be made as a flying pest exterminating composition having a high extermination effect even without containing an insecticidal component, and therefore, it has high safety for the human body and the environment.

In addition, the flying pest exterminating spray of the present invention may be applied to not only pests during flying but also, for example, flying pests landing on the wall or the ground.

The details of the flying pest exterminating composition of the present invention are hereunder described.

### <Component (A): Surfactant>

The flying pest exterminating composition of the present invention can wet alae of flying pests by containing the surfactant (A).

Examples of the surfactant (A) in the present invention include a cationic surfactant, an anionic surfactant, an amphoteric surfactant, and a nonionic surfactant.

Among the surfactants, from the viewpoint of safety for the human body and the environment, it is preferable to include at least one selected from a cationic surfactant, an anionic surfactant, and a nonionic surfactant, it is more preferable to include at least one selected from an anionic surfactant and a nonionic surfactant, it is still more preferable to include a nonionic surfactant, and it is even more preferable to be a nonionic surfactant.

The content of the component (A) in the composition of the present invention is preferably 0.05% by mass or more, more preferably 0.10% by mass or more, and still more preferably 0.15% by mass or more from the viewpoint that the action to wet alae of the flying pest is excellent, and is preferably 5.0% by mass or less, more preferably 4.0% by mass or less, and still more preferably 3.0% by mass or less from the viewpoint of enhancing the straightness of the sprayed product of the composition and efficiently exterminating flying pests.

Further, the content of the component (A) in the composition of the present invention is preferably 2.0% by mass or less, more preferably 1.5% by mass or less, still more preferably 1.2% by mass or less, and even more preferably 1.0% by mass or less from the viewpoint of suppressing stickiness and slipperiness caused by the sprayed composition attaching to the surface to be sprayed. Although the use place is not particularly limited, for example, in the case of being used indoors, the stickiness and the slipperiness to the floor, the wall, or the like can be suppressed, and the handleability can be made more favorable.

It is preferable that the surfactant (A) contains a surfactant (A2) other than at least one surfactant (A1) selected from 2-ethylhexyl glyceryl ether, N-lauroyl-N-methyltaurine salt, dodecylsulfate, and lauryl trimethylammonium salt from the viewpoint that the sprayed product can be easily controlled to a specific volume particle size distribution (hereinafter, also referred to as a “viewpoint of easily controlling the particle size distribution”).

Examples of the surfactant (A2) include at least one selected from a cationic surfactant, an anionic surfactant, an amphoteric surfactant, and a nonionic surfactant.

In addition, since the surfactant (A1) has an excellent foam-increasing function, it is also one of preferable aspects to use the surfactant (A1) and the surfactant (A2) in combination.

Here, as the salt in the N-lauroyl-N-methyltaurine salt, the dodecylsulfate, and the lauryl trimethylammonium salt in the surfactant (A1), an alkali metal salt is preferable, at least one selected from a sodium salt and a potassium salt is more preferable, and a sodium salt is still more preferable.

When the surfactant (A2) is at least one selected from a cationic surfactant, an anionic surfactant, and an amphoteric surfactant, the content of the surfactant (A1) is preferably 0% by mass or more and 1.0% by mass or less, and the content of the surfactant (A2) is preferably more than 0.2% by mass and 2.0% by mass or less, from the viewpoint of easily controlling the state of the sprayed product having a specific volume particle size distribution. In this case, the content of the surfactant (A1) is preferably 0.8% by mass or less, more preferably 0.5% by mass or less, still more preferably 0.3% by mass or less, and even more preferably 0.2% by mass or less, from the viewpoint of easily controlling the particle size distribution. The content of the surfactant (A2) is preferably 0.22% by mass or more, more preferably 0.23% by mass or more, still more preferably 0.3% by mass or more, even more preferably 0.4% by mass or more, and yet still more preferably 0.45% by mass or more from the viewpoint of easily controlling the particle size distribution, and is preferably 1.5% by mass or less, more preferably 1.0% by mass or less, still more preferably 0.8% by mass or less, and even more preferably 0.6% by mass or less from the same viewpoint.

Further, when the surfactant (A2) is at least one selected from a cationic surfactant, an anionic surfactant, and an amphoteric surfactant, the content of the surfactant (A1) is preferably 0.01% by mass or more and 1.0% by mass or less, and the content of the surfactant (A2) is preferably 0.1% by mass or more and 2.0% by mass or less, from the viewpoint of easily controlling the particle size distribution. In this case, the content of the surfactant (A1) is preferably 0.02% by mass or more and more preferably 0.03% by mass or more from the viewpoint of easily controlling the particle size distribution, and is preferably 0.8% by mass or less, more preferably 0.5% by mass or less, still more preferably 0.3% by mass or less, and even more preferably 0.1% by mass or less from the same viewpoint. The content of the surfactant (A2) is preferably 0.12% by mass or more and more preferably 0.15% by mass or more from the viewpoint of easily controlling the particle size distribution, and is preferably 1.0% by mass or less, more preferably 0.5% by mass or less, still more preferably 0.3% by mass or less, and even more preferably 0.2% by mass or less from the same viewpoint.

In addition, the ratio of the surfactant (A1)/the surfactant (A2) is preferably 0.1 or more and more preferably 0.2 or more from the viewpoint of easily controlling the particle size distribution, and is preferably 1 or less and more preferably 0.5 or less from the same viewpoint.

In addition, when the surfactant (A2) is a nonionic surfactant, the content of the surfactant (A1) is preferably 0.01% by mass or more and 1.0% by mass or less and the content of the surfactant (A2) is preferably 0.1% by mass or more and 2.0% by mass or less from the viewpoint of easily controlling the particle size distribution. In this case, the content of the surfactant (A1) is preferably 0.05% by mass or more, more preferably 0.1% by mass or more, still more preferably 0.2% by mass or more, and even more preferably 0.3% by mass or more from the viewpoint of easily controlling the particle size distribution, and is preferably 0.8% by mass or less, more preferably 0.7% by mass or less, and still more preferably 0.6% by mass or less from the same viewpoint. The content of the surfactant (A2) is preferably 0.2% by mass or more, more preferably 0.3% by mass or more, and still more preferably 0.4% by mass or more from the viewpoint of easily controlling the particle size distribution, and is preferably 1.5% by mass or less, more preferably 1.0% by mass or less, still more preferably 0.8% by mass or less, and even more preferably 0.6% by mass or less from the same viewpoint.

Examples of the surfactant (A2) include at least one selected from a cationic surfactant, an anionic surfactant, an amphoteric surfactant, and a nonionic surfactant.

### [Cationic Surfactant]

Examples of the cationic surfactant include at least one selected from quaternary ammonium salts having an alkyl group having 10 or more and 18 or less carbon atoms (excluding lauryl trimethylammonium salts).

Examples of the cationic surfactant include an alkyl trimethylammonium salt, an alkoxyalkyl trimethylammonium salt, a dialkyl dimethylammonium salt, an alkylamidoalkyl trimethylammonium salt, a benzalkonium chloride (hereinafter, also referred to as “alkyl (C12-16) benzyldimethylammonium chloride”), an alkyl pyridinium salt, an alkyl dimethylamine and a salt thereof, an alkoxyalkyl dimethylamine and a salt thereof, an alkylamidoalkyl dimethylamine and a salt thereof, a diethanolamine monoalkyl ester and a salt thereof, a triethanolamine monoalkyl ester and a salt thereof, and a triethanolamine dialkyl ester and a salt thereof.

Examples of a counter ion of the cationic group in the alkyl trimethylammonium salt, the alkoxyalkyl trimethylammonium salt, the dialkyl dimethylammonium salt, the alkylamidoalkyl trimethylammonium salt, and the alkyl pyridinium salt include an alkyl sulfate ion having 1 or more and 3 or less carbon atoms, a sulfuric acid ion, a phosphoric acid ion, a carboxylic acid ion having 1 or more and 3 or less carbon atoms (e.g., a formic acid ion, an acetic acid ion, and a propionic acid ion), and a halide ion, such as a chloride ion and a bromide ion. Of these, from the viewpoint of easiness of production and easiness of availability of raw materials, a halide ion is preferred, and a chloride ion is more preferred.

Each of the alkyl dimethylamine, the alkoxyalkyl dimethylamine, the alkylamidoalkyl dimethylamine, the diethanolamine monoalkyl ester, the triethanolamine monoalkyl ester, and the triethanolamine dialkyl ester may be previously reacted with an acid and then blended as the salt in the composition; or it may be blended directly in the composition, with which is then blended an acid to form a salt in the composition. In consequence, the aforementioned amine, alkyl ester, and salt thereof are herein defined as the cationic surfactant.

Examples of the salt of each of the alkyl dimethylamine, the alkoxyalkyl dimethylamine, the alkylamidoalkyl dimethylamine, the diethanolamine monoalkyl ester, the triethanolamine monoalkyl ester, and the triethanolamine dialkyl ester include salts of an organic acid or an inorganic acid. Examples of the organic acid include a monocarboxylic acid, such as acetic acid and propionic acid; a dicarboxylic acid, such as malonic acid, succinic acid, glutaric acid, adipic acid, maleic acid, fumaric acid, and phthalic acid; a polycarboxylic acid, such as polyglutamic acid; a hydroxycarboxylic acid, such as glycolic acid, lactic acid, hydroxyacrylic acid, glyceric acid, malic acid, tartaric acid, and citric acid; and an acidic amino acid, such as glutamic acid and aspartic acid. Examples of the inorganic acid include hydrochloric acid, sulfuric acid, and phosphoric acid.

From the viewpoint that the action to wet alae of the flying pest is excellent and the viewpoint that the straightness of the sprayed product is enhanced to efficiently exterminate the flying pests, the cationic surfactant is preferably benzalkonium chloride.

### [Anionic Surfactant]

Examples of the anionic surfactant include at least one selected from a salt of a mono- or di-ester of an aliphatic alcohol having 5 or more and 18 or less carbon atoms and sulfosuccinic acid (hereinafter, also referred to as a “sulfosuccinic acid ester salt”), an alkyl or alkenyl sulfate ester salt having an alkyl group having 10 or more and 18 or less carbon atoms (excluding dodecylsulfate), a polyoxyalkylene alkyl ether sulfate ester salt, an N-acylamino acid salt, an N-acyl-N-methylamino acid salt, a linear alkylbenzenesulfonate, and a fatty acid salt. Among these, from the viewpoint of enhancing the straightness of the sprayed product and efficiently exterminating flying pests, a mono- or di-ester salt of an aliphatic alcohol having 5 or more and 18 or less carbon atoms and sulfosuccinic acid, and a polyoxyalkylene alkyl ether sulfate ester salt are preferable, and a mono- or di-ester salt of an aliphatic alcohol having 5 or more and 18 or less carbon atoms and sulfosuccinic acid is more preferable.

The sulfosuccinic acid ester salt is preferably a salt of a diester.

The number of carbon atoms of the aliphatic alcohol constituting the sulfosuccinic acid ester salt is 5 or more, preferably 6 or more, and more preferably 7 or more, and 18 or less, preferably 14 or less, and more preferably 10 or less.

The salt in the sulfosuccinic acid ester salt is preferably an alkali metal salt, more preferably at least one selected from a sodium salt and a potassium salt, and still more preferably a sodium salt.

The number of carbon atoms of the alkyl group constituting the polyoxyalkylene alkyl ether sulfate ester salt is preferably 6 or more, more preferably 8 or more, still more preferably 10 or more, and even more preferably 12 or more, and preferably 20 or less, more preferably 16 or less, and still more preferably 14 or less.

Examples of a counter ion of the anionic group of the anionic surfactant include an alkali metal ion such as a sodium ion and a potassium ion; an alkaline earth metal ion such as a calcium ion and a magnesium ion; an ammonium ion; and an alkanolammonium having 1 to 3 alkanol groups having 2 or 3 carbon atoms (for example, monoethanolammonium, diethanolammonium, triethanolammonium, and triisopropanolammonium). Among these, a sodium ion and a potassium ion are preferable, and a sodium ion is more preferable.

### [Amphoteric Surfactant]

Examples of the amphoteric surfactant include at least one selected from alkylamine oxides having an alkyl group having 10 or more and 18 or less carbon atoms and alkyl betaines having an alkyl group having 10 or more and 18 or less carbon atoms.

### [Nonionic Surfactant]

Examples of the nonionic surfactant include at least one selected from a polyoxyalkylene alkyl ether, a polyoxyalkylene sorbitan fatty acid ester, an alkyl glucoside, an alkyl glyceryl ether (excluding 2-ethylhexyl glyceryl ether), a polyglycerin fatty acid ester, a polyoxyethylene hydrogenated castor oil, a polyoxyethylene alkylamine, and a polyoxyethylene-modified silicone.

Among the nonionic surfactants, a nonionic surfactant having an HLB (hydrophile-lipophile balance) value of 18.0 or less is preferable from the viewpoint that the action to wet alae of the flying pest is excellent. The foregoing HLB value is more preferably 16.0 or less, and still more preferably 15.0 or less. As the nonionic surfactant, for example, at least one selected from a polyoxyalkylene alkyl ether, an alkyl glucoside, and an alkyl glyceryl ether is preferable, and at least one selected from a polyoxyalkylene alkyl ether and an alkyl glucoside is more preferable. Here, the HLB value is a value exhibiting an affinity of the surfactant with water and an oil and can be determined by the Griffin method according to following equation. In the case where the nonionic surfactant is composed of two or more components, the HLB is one determined as a weighted average value while making a blending ratio of each component as a weight on the basis of the HLB value of each component. In the following equation, examples of the “hydrophilic groups contained in the surfactant” include a hydroxy group and an ethyleneoxy group.

HLB=20×[(Sum total of formula weights of hydrophilic groups contained in the surfactant)/(Molecular weight of the surfactant)]

The polyoxyalkylene alkyl ether is preferably a compound represented by the following general formula (1).

R¹—O—(Y)ₘ—H (1)

In the formula (1), R¹ represents an alkyl group; Y represents an oxyethylene unit and/or an oxypropylene unit; and m represents an average addition molar number of Y.

In the general formula (1), the number of carbon atoms of the alkyl group constituting R¹ is preferably 8 or more and 22 or less, more preferably 8 or more and 18 or less, and still more preferably 8 or more and 14 or less, from the viewpoint that the action to wet alae of the flying pest is excellent. Although the alkyl group may be any of a linear alkyl group and a branched alkyl group, it is preferably a linear alkyl group from the viewpoint that the surface tension is lowered, and the action to wet alae of the flying pest is excellent.

Y represents an oxyethylene unit and/or an oxypropylene unit, and Y is preferably an oxyethylene unit. m represents an average addition molar number of Y, and m is preferably 4 or more, and more preferably 6 or more from the viewpoint of enhancing the straightness of the sprayed product of the composition to efficiently exterminate the flying pests. In addition, from the viewpoint that the action to wet alae of the flying pest is excellent, the foregoing average addition molar number is preferably 30 or less, more preferably 20 or less, still more preferably 15 or less, even more preferably 12 or less, and yet still more preferably 10 or less.

The polyoxyalkylene alkyl ether is more preferably a polyoxyethylene lauryl ether in which the average addition molar number of the oxyethylene group is 6 or more and 10 or less.

Examples of the alkyl glucoside include an alkyl glucoside having an alkyl group having preferably 8 or more and 22 or less carbon atoms, more preferably 8 or more and 18 or less carbon atoms, and still more preferably 8 or more and 14 or less carbon atoms. The alkyl group may be any of a linear alkyl group and a branched alkyl group.

Specific examples of the alkyl glucoside include octyl glucoside, 2-ethylhexyl glucoside, nonyl glucoside, decyl glucoside, isodecyl glucoside, lauryl glucoside, tridecyl glucoside, myristyl glucoside, stearyl glucoside, isostearyl glucoside, and a mixture of two or more thereof. Among these, at least one selected from decyl glucoside, lauryl glucoside, and myristyl glucoside is preferable.

Examples of the alkyl glyceryl ether include an alkyl glyceryl ether having an alkyl group having preferably 8 or more and 22 or less carbon atoms, more preferably 8 or more and 18 or less carbon atoms, and still more preferably 8 or more and 14 or less carbon atoms. Although the alkyl group may be any of a linear alkyl group and a branched alkyl group, it is preferably a branched alkyl group from the viewpoint of enhancing the straightness of the sprayed product of the composition to efficiently exterminate the flying pests.

Specific examples of the alkyl glyceryl ether include octyl glyceryl ether, nonyl glyceryl ether, decyl glyceryl ether, isodecyl glyceryl ether, lauryl glyceryl ether, tridecyl glyceryl ether, myristyl glyceryl ether, stearyl glyceryl ether, isostearyl glyceryl ether, and a mixture of two or more thereof. Among these, at least one selected from decyl glyceryl ether, isodecyl glyceryl ether, and lauryl glyceryl ether is preferable, and isodecyl glyceryl ether is more preferable.

As the surfactant (A), one kind or a combination of two or more kinds can be contained. In addition, the content of the surfactant in the composition is an amount as a dissociation type when the surfactant is present in a dissociated state in the composition. That is, in the case of sodium dioctyl sulfosuccinate, the content is an amount as dioctyl sulfosuccinate. In addition, in some cases, the dissociation state of the amphoteric surfactant changes depending on the pH of the composition, resulting in a mixture of a dissociation type and a non-dissociation type. In such a case, the content of the amphoteric surfactant in the composition is an amount including the dissociation type and the non-dissociation type.

### <Water>

The flying pest exterminating composition of the present invention contains water as a medium for dissolving or dispersing the surfactant (A) which is an active ingredient for exterminating flying pests.

The content of water in the composition is preferably 80% by mass or more, more preferably 85% by mass or more, still more preferably 90% by mass or more, even more preferably 95% by mass or more, and yet still more preferably 98% by mass or more, and preferably 99.89% by mass or less, and more preferably 99.85% by mass or less, from the viewpoint of safety for the human body and the environment and from the viewpoint of easily controlling the particle size of the sprayed product of the composition to a particle size suitable for spraying.

### <Other Components>

The flying pest exterminating composition of the present invention can also contain components other than the surfactant (A) and water, for example, an organic acid, an organic acid salt, a preservative, a colorant, a fragrance, a pH modifier, and the like, to the extent that the effects of the invention are not impaired. In addition, an aqueous medium other than water, for example, an alcohol having 1 to 5 carbon atoms, such as methanol, ethanol, isopropyl alcohol, and butyl alcohol; and a diol or triol having 6 or less carbon atoms, such as 1,3-butylene glycol, glycerin, ethylene glycol, and propylene glycol, may be contained.

However, from the viewpoint of obtaining the effects of the present invention, the content of components other than the surfactant (A) and water in the flying pest exterminating composition is preferably 20% by mass or less, more preferably 15% by mass or less, still more preferably 10% by mass or less, even more preferably 5% by mass or less, yet still more preferably 1% by mass or less, yet even more preferably 0.5% by mass or less, and still further preferably 0.1% by mass or less.

From the viewpoint of safety for the human body and the environment, it is preferable that the flying pest exterminating composition of the present invention does not contain an insecticidal component other than an organic acid and an organic acid salt. The flying pest exterminating composition of the present invention contains the surfactant (A) which is excellent in safety for the human body and the environment and can effectively wet alae of flying pests. This is because the foregoing surfactant (A) is contained in the composition as an active ingredient for exterminating flying pests, and a composition having a high extermination effect of flying pests can be obtained even without containing an insecticidal component.

Examples of the insecticidal component mentioned herein include a pyrethroid-based insecticide, an organophosphorus-based insecticidal component, a carbamate-based insecticidal component, an insecticidal component described in Groups 1 to 32 of IRAC MoA Classification Version 9.4 (March 2020), and an insecticide described in paragraph 0049 of WO 2018/079565 (excluding those corresponding to an organic acid and an organic acid salt).

Examples of the pyrethroid-based insecticide include metofluthrin, dl,d-T80-allethrin, phthalthrin, d-T80-phthalthrin, d,d-T80-prallethrin, d,d-T98-prallethrin, d-T80-resmethrin, transfluthrin, imiprothrin, cyphenothrin, d,d-T-cyphenothrin, empenthrin, permethrin, phenothrin, etofenprox, and pyrethrin.

Examples of other insecticidal component than the pyrethroid-based insecticide include an organophosphorus-based insecticide, such as fenitrothion and malathion; a carbamate-based insecticide, such as propoxur and carbaryl; a miticide, such as kelthane, quinomethionate, and hexathiazox; and a neonicotinoid-based insecticide, such as imidacloprid, dinotefuran, and clothianidin.

The phrase “does not contain an insecticidal component other than an organic acid and an organic acid salt” means that the content of the insecticidal component other than an organic acid and an organic acid salt in the flying pest exterminating composition is less than 1% by mass, preferably 0.1% by mass or less, more preferably 0.01% by mass or less, still more preferably 0.001% by mass or less, and even more preferably, the insecticidal component is not substantially contained. In the description herein, “not substantially contained” means that it is not added intentionally, and it does not exclude that it is contained in a trace amount as an impurity.

Organic acids and organic acid salts are excellent in safety for the human body and the environment. Therefore, the flying pest exterminating composition of the present invention may contain an organic acid and an organic acid salt as an insecticidal component to the extent that the effects of the invention are not impaired.

Examples of the organic acid and the organic acid salt include benzoic acid, lactic acid, sorbic acid, tartaric acid, fumaric acid, malic acid, citric acid, and salts thereof, and these can be used alone or in combination of two or more kinds thereof.

From the viewpoint of further improving insecticidal properties, the salt in the organic acid salt is preferably an alkali metal salt, more preferably at least one selected from a sodium salt and a potassium salt, and still more preferably a sodium salt.

It is preferable that the content of the film-formable polymer in the flying pest exterminating composition of the present invention is small from the viewpoint of easily adjusting the viscosity of the flying pest exterminating composition to a viscosity suitable for spraying; from the viewpoint of easily controlling the volume particle size distribution of the sprayed product to a distribution suitable for spraying (in particular, reducing the proportion of the sprayed product having a particle diameter of 1483 μm or more and 1926 μm or less); and from the viewpoint of suppressing stickiness caused by the sprayed composition attaching to the surface to be sprayed during using the flying pest exterminating composition.

For example, the content of the film-formable polymer in the flying pest exterminating composition is preferably 0.5% by mass or less, more preferably less than 0.1% by mass, still more preferably 0.07% by mass or less, even more preferably 0.05% by mass or less, and yet still more preferably 0.01% by mass or less.

Examples of the film-formable polymer include a (meth)acrylic acid alkyl ester copolymer, a silicone structure-containing polymer, a vinyl-based polymer, a urethane-based polymer, and a polysaccharide-based polymer. The (meth)acrylic acid alkyl ester copolymer means a polymer compound resulting from copolymerization of a (meth)acrylic acid alkyl ester, and in particular, a film-formable (meth)acrylic acid alkyl ester copolymer is corresponding thereto.

The film-formable (meth)acrylic acid alkyl ester copolymer may be any of cationic, anionic, nonionic, and amphoteric polymer compounds. Among the film-formable (meth)acrylic acid alkyl ester copolymers, examples of the amphoteric polymer compound include an N-methacryloyloxyethyl N,N-dimethylammonium-α-N-methylcarboxybetaine/methacrylic acid alkyl ester copolymer (e.g., “YUKA FORMER 202”, “YUKA FORMER 104D”, “YUKA FORMER AMPHOSET”, “YUKA FORMER R205S”, and “YUKA FORMER SM”, all of which are manufactured by Mitsubishi Chemical Corporation), an octylamide acrylate/hydroxypropyl acrylate/butylaminoethyl methacrylate copolymer, and an N-methacryloyloxyethyl N,N-dimethylaminoethyl-α-N-methyl carboxybetaine/alkyl ester methacrylate copolymer.

When the content of the film-formable polymer in the flying pest exterminating composition of the present invention is small, an increase in viscosity of the composition is suppressed. For that reason, in the case of using a trigger spray type container as the spray container, a speed of pulling a trigger is not lowered and is stabilized. When the speed of pulling a trigger is fast, since the pressure applied to the droplets becomes high, the sprayed product of the composition readily becomes small. In addition, in view of the fact that the speed of pulling a trigger becomes stable, when the liquid film of the composition comes loose into droplets due to a power of spinning, the sprayed product readily becomes small, and the particle diameter control becomes easy.

The production method of the flying pest exterminating composition of the present invention is not particularly limited. For example, the flying pest exterminating composition can be produced by blending the surfactant (A), water, and other components which are used as the need arises and mixing the blend using a known stirring device or the like.

### <Volume Particle Size Distribution of Sprayed Product>

As described above, the volume particle size distribution of the sprayed product is a volume particle size distribution of a flying pest exterminating composition sprayed using a spray container, and is a value measured using a Spraytec laser diffraction system (manufactured by Malvern Panalytical Instrument, Model No. STP5921, equipped with a 750 mm lens manufactured by the same company) by the laser diffraction method with respect to the sprayed product at a position of 30 cm in terms of a horizontal distance from an injection port of the spray container in which the composition is filled and discharged, and specifically, it can be measured by a method described in Examples. The measurement range of the volume particle size distribution by this method is 1 to 3,000 μm.

It is more preferable that the volume particle size distribution of the sprayed flying pest exterminating composition at a position of 30 cm in terms of a horizontal distance from an injection port of a spray container satisfies the following requirements.

The proportion of the sprayed product having a particle diameter of 310 μm or less is 70% by volume or more, preferably 71% by volume or more, and more preferably 72% by volume or more from the viewpoint of increasing the amount of the sprayed product to be reached and allowing the composition to efficiently reach flying pests, and is 95% by volume or less, preferably 93% by volume or less, more preferably 91% by volume or less, and still more preferably 90% by volume or less from the same viewpoint.

The proportion of the sprayed product having a particle diameter of 354 μm or more and 773 μm or less is 0.05% by volume or more, preferably 0.08% by volume or more, more preferably 0.10% by volume or more, and still more preferably 0.12% by volume or more from the viewpoint of increasing the amount of the sprayed product to be reached and allowing the composition to efficiently reach flying pests, and is preferably 20% by volume or less, more preferably 15% by volume or less, still more preferably 12% by volume or less, and even more preferably 10% by volume or less from the same viewpoint.

The proportion of the sprayed product having a particle diameter of 1483 μm or more and 1926 μm or less is 4.90% by volume or less, preferably 4.7% by volume or less, more preferably 4.5% by volume or less, still more preferably 4.3% by volume or less, even more preferably 4.0% by volume or less, and yet still more preferably 3.5% by volume or less, from the viewpoint of increasing the amount of the sprayed product to be reached and allowing the composition to efficiently reach flying pests. The lower limit is not particularly limited, but is, for example, 0.1% by volume or more, and may be 1.0% by volume or more.

The volume particle size distribution of the sprayed product can be controlled by, for example, the surfactant (A) used in the composition and the content thereof, the injection orifice diameter of the spray container used, and a combination thereof. In particular, by selecting a combination of the surfactant (A) and the content thereof such that the amount of change in the dynamic surface tension of the flying pest exterminating composition of the present invention is small, the volume particle size distribution of the sprayed product can be controlled to the above-mentioned distribution. It is considered that, in a case where the amount of change in the dynamic surface tension is small, even in a case where a spraying rate is high, microbubbles are easily formed, and the volume particle size distribution of the sprayed product is easily controlled to the above-mentioned distribution.

### <Trigger Spray Type Spray Container>

The trigger spray type spray container used in the flying pest exterminating spray of the present invention is not particularly limited as long as it can be filled with the aforementioned flying pest exterminating composition and sprayed on flying pests in the state of a sprayed product having a specific volume particle size distribution.

The volume of the trigger spray type spray container is not particularly limited, and is, for example, 50 mL or more and 500 mL or less from the viewpoint of spraying toward flying pests.

An injection orifice diameter of the trigger spray type spray container is preferably 0.1 mm or more, more preferably 0.2 mm or more, and still more preferably 0.3 mm or more from the viewpoint of being easily controlled to a state of a sprayed product having a specific volume particle size distribution, and is preferably 1.5 mm or less, more preferably 1.2 mm or less, and still more preferably 1.0 mm or less from the same viewpoint. In addition, the “injection orifice diameter of the trigger spray type spray container” means a maximum diameter in the inner diameter of the injection nozzle tip of the trigger spray type spray container. Although the shape of the discharge port is not particularly limited, it is preferably circular or oval.

From the viewpoint of easily controlling to a state of a sprayed product having a specific volume particle size distribution, among the trigger spray type container, an accumulation type trigger spray container is more preferable. In general, the accumulation type spray container has a structure in which a piston is slid relative to a cylinder accommodated inside the container, to inject a liquid exceeding a fixed pressure within the cylinder from a nozzle. That is, since the liquid is first injected outside the container in the case where the liquid pressure within the cylinder exceeds the fixed pressure, the accumulation type trigger spray container is advantageous from the standpoint of particle diameter control of the droplets injected.

Examples of the accumulation type trigger spray container include a container described in JP 2017-226474 A.

In addition, the trigger spray type container may be provided with a foam-forming mechanism, but it is preferable that the trigger spray type container does not have a foam-forming mechanism from the viewpoint that it is easy to control to a state of a sprayed product having a specific volume particle size distribution.

Specifically, the “foam forming mechanism” means the following mechanism (1) or (2).
(1) A mechanism having a projection-provided plate-shaped body or a mesh-like barrier, as arranged in an injection port of the container vertically to the injection direction, in which the liquid injected in the form of mist is allowed to collide against the plate-shaped body or the barrier, thereby mixing with air to form foams.
(2) A mechanism having an outside air introduction hole in the vicinity of an injection port of a container, in which the liquid injected in the form of mist is mixed with the introduced outside air within the container and collides against a cylindrical inner wall surface to form foams, which are then injected forward from the injection port.

Specific examples of the above (1) include mechanisms described in FIG. 15 of JP2003-112090A, JP2011-251218A, and FIG. 2 of JP2006-320845A.

Specific examples of the above (2) include mechanisms described in FIG. 2 of JP2007-167719A, FIG. 2 of JP2006-150279A, and FIG. 2 of JPS52-116919 A.

The trigger spray type container having no foam forming mechanism refers to a trigger spray type container of a structure in which the liquid is injected as liquid droplets from the injection port of the nozzle to the outside of the container without going through the aforementioned foam forming mechanism, and preferably, it refers to a trigger spray type container of a structure in which the droplets are injected directly into the outside of the container from the injection port of the nozzle.

The appearance shape of the sprayed product discharged from the trigger spray type container having no foam forming mechanism is preferably one in which after 1 minute of spraying one time with a full stroke toward a wall located at a horizontal distance of 30 cm from the injection port of the container at room temperature (25° C.), no bubbles having a size of 100 μm or more are observed. The appearance shape of the sprayed product is more preferably one in which after 0.5 minutes of spraying one time with a full stroke toward a wall located at a horizontal distance of 30 cm from the injection port of the container, no bubbles having a size of 100 μm or more are observed.

From the viewpoint that the particle size distribution can be easily controlled, it is preferable that the content of a propellant in the flying pest exterminating spray of the present invention is small. For example, the content of the propellant in the flying pest exterminating spray is preferably less than 3% by mass, more preferably less than 1% by mass, still more preferably 0.5% by mass or less, even more preferably 0.1% by mass or less, and yet still more preferably 0.05% by mass or less, based on 100% by mass of the total amount of the flying pest exterminating composition and the propellant.

The propellant means a gas used to eject contents in an aerosol type container. Examples of the propellant include liquefied gases such as a liquefied petroleum gas, dimethyl ether, and a halogenated hydrocarbon; and compressed gases such as nitrogen, compressed air, carbon dioxide gas, nitrous oxide, argon, and helium.

### [Flying Pest Exterminating Composition]

The composition of the second aspect of the present invention (hereinafter, also referred to as a “second composition”, and the composition of the present invention used in the above-mentioned flying pest exterminating spray of the present invention is also referred to as a “first composition”) is a flying pest exterminating composition to be used by spraying on flying pests, containing a surfactant (A) and water, and in the volume particle size distribution of a sprayed product of the flying pest exterminating composition measured by the following Measurement Method 1 at a position of 30 cm in terms of a horizontal distance from an injection port of a spray container filled with the flying pest exterminating composition, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

### (Measurement Method 1)

A flying pest exterminating composition filled in a trigger spray type spray container (injection orifice diameter: 0.8 mm) is sprayed at a spraying rate of 3.0 g/sec or more and 4.5 g/sec or less by performing a trigger operation once, and the volume particle size distribution of the sprayed flying pest exterminating composition at a position of 30 cm in terms of a horizontal distance from the injection port of the spray container is measured by a laser diffraction method.

The second composition is a flying pest exterminating composition, which is used by spraying on flying pests, has high straightness when the composition is sprayed from a spray, can efficiently reach flying pests, and can improve the extermination effect.

In addition, the second composition is one having a function of reducing a flying ability of flying pests by bringing the composition into contact with alae of a flying pest, and exhibits an extermination effect of flying pests by an action mechanism such as suppressing the flying of the flying pest or dropping the flying pest flying or landing on a wall or the like onto the ground.

The reason why the effect of the second composition is obtained is considered to be the same as the reason why the effect of the flying pest exterminating spray of the present invention described above is obtained.

Each component constituting the second composition and a suitable aspect thereof are the same as those of the first composition described above.

The spray container used in the flying pest exterminating spray filled with the second composition and the suitable aspect thereof are the same as those of the flying pest exterminating spray filled with the first composition described above.

The suitable aspect of the volume particle size distribution of the sprayed product in the second composition is the same as the suitable aspect of the volume particle size distribution of the sprayed product in the flying pest exterminating spray of the present invention described above.

### [Method for Exterminating Flying Pests]

The method for exterminating flying pests of the present invention includes a step of spraying a flying pest exterminating composition, which is filled in a spray container (hereinafter, also referred to as a “third composition”), to the flying pests, in which the flying pest exterminating composition contains a surfactant (A) and water, and in the volume particle size distribution of a sprayed product of the flying pest exterminating composition at a position of 30 cm in terms of a horizontal distance from an injection port of the spray container, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

Here, the spraying from the injection port of the spray container can be performed by, for example, pulling with a full stroke over 0.35 to 0.45 seconds at a substantially constant pressure so that the spraying direction from the injection port of the spray container becomes horizontal with respect to the ground.

The method for exterminating flying pests of the present invention can have high straightness when a composition is sprayed from a spray, can allow a flying pest exterminating composition to efficiently reach flying pests, and can improve the extermination effect.

In addition, the method for exterminating flying pests of the present invention has a function of reducing a flying ability of flying pests by bringing the composition into contact with alae of a flying pest, and exhibits an extermination effect of flying pests by making the composition harmless by an action mechanism such as suppressing the flying of the flying pest or dropping the flying pest flying or landing on a wall or the like onto the ground.

The reason why the effect of the method for exterminating flying pests of the present invention is obtained is considered to be the same as the reason why the effect of the flying pest exterminating spray of the present invention described above is obtained.

Each component constituting the third composition and a suitable aspect thereof are the same as those of the first composition described above.

In the method for exterminating flying pests of the present invention, the spray container used in the flying pest exterminating spray filled with the third composition and the suitable aspect thereof are the same as those of the flying pest exterminating spray filled with the first composition described above.

The suitable aspect of the volume particle size distribution of the sprayed product in the method for exterminating flying pests of the present invention is the same as the suitable aspect of the volume particle size distribution of the sprayed product in the flying pest exterminating spray of the present invention described above.

The discharge amount of the flying pest exterminating composition by the trigger spray type container is preferably 0.2 g/time or more, more preferably 0.5 g/time or more, and still more preferably 0.7 g/time or more in terms of a discharge amount per one time of trigger operation from the viewpoint of making a sufficient amount of sprayed product reach a flying pest to efficiently exterminate the flying pest. Further, the discharge amount is preferably 2.0 g/time or less, more preferably 1.5 g/time or less, and still more preferably 1.2 g/time or less from the viewpoint that when using the flying pest exterminating spray, stickiness to be caused due to attachment of the sprayed composition onto the surface to be sprayed is suppressed.

### EXAMPLES

Hereinafter, the present invention will be described by Examples, but the present invention is not limited to the scope of the Examples. In the present Examples, various evaluations were performed by the following methods.

### (Volume Particle Size Distribution of Sprayed Product)

The volume particle size distribution of the sprayed product was measured at room temperature (25° C.) by the laser diffraction method using a Spraytec laser diffraction system (manufactured by Malvern Panalytical Instrument, Model No.; STP5921, equipped with a 750 mm lens manufactured by the same company). A spray in which the composition of each example was filled in a trigger spray type spray container (trigger type: pressure accumulation, volume of 370 mL, injection orifice diameter of 0.8 mm, discharge amount: 0.9 g/time) (a trigger type sprayer of Resesh Clear Sterilization EX (manufactured by Kao Corporation)) was installed so that the tip of the injection nozzle of the spray container was located at a position of 30 cm in terms of a horizontal distance until a measurement area of the laser diffraction system, the trigger operation was performed one time to spray the composition, and the volume particle size distribution of the sprayed product detected in the measurement area having a laser length of 34 cm and a laser width of 1.8 cm was measured. The measurement range of the volume particle size distribution by this measuring instrument is 1 to 3,000 μm.

In the trigger operation, the trigger was pulled with a full stroke at a substantially constant pressure so that the spray direction from the injection port of the spray container was horizontal to the ground, the trigger operation time (time from the start to the end of pulling the trigger) was 0.38 seconds, the liquid discharge time (time from the start to the end of discharging the liquid) was 0.22 seconds, and the spraying rate (discharge amount/liquid discharge time) was 4.0 g/second.

### (Reach Amount of Sprayed Product)

Each of the flying pest exterminating compositions shown in Tables 1 and 2 was filled in a trigger spray type spray container (trigger type: pressure accumulation, volume of 370 mL, injection orifice diameter of 0.8 mm, discharge amount: 0.9 g/time) (a trigger type sprayer of Resesh Clear Sterilization EX (manufactured by Kao Corporation)) to prepare a spray.

The reach amount of the sprayed product was measured by spraying the aqueous solution onto filter paper (filter paper #1, diameter of 300 mm, manufactured by Advantec Toyo Kaisha, Ltd.). To be specific, before the evaluation, the mass of the filter paper before spraying and the mass of the spray container before spraying were measured, and then the spray was fixed such that the tip (i.e., the injection port) of the injection nozzle of the spray container was located at a position where the horizontal distance to the filter paper was 30 cm, and the aqueous solution was sprayed by performing a trigger operation once toward the filter paper. After spraying, the mass of the filter paper after spraying and the mass of the spray container after spraying were measured. The reaching rate of the sprayed product per spraying once was calculated by the following calculation formula.

Reaching rate of sprayed product (%)={(mass of filter paper after spraying(g))−(mass of filter paper before spraying(g))}×100/{(mass of spray container before spraying(g))−(mass of spray container after spraying(g))}

As the reach amount of the sprayed product is larger, it can be determined that the composition is a flying pest exterminating composition having a higher straightness of the sprayed product and having an excellent action capable of efficiently reaching flying pests.

In Examples and Comparative Examples, the following surfactants and film-formable polymers were used.

### (Surfactant (A1))

2-Ethylhexyl glyceryl ether (manufactured by Kao Corporation, product name: PENETOL GE-EH)
Sodium N-lauroyl-N-methyltaurine (manufactured by Nippon Surfactant Industries Co., Ltd., product name: NIKKOL LMT-P)
Sodium dodecylsulfate (manufactured by Kao Corporation, product name: EMAL 0)
Lauryl trimethylammonium chloride (manufactured by FUJIFILM Wako Chemical Corporation)

### (Surfactant (A2))

Sodium dioctyl sulfosuccinate (manufactured by TOHO Chemical Industry Co., Ltd., product name: AIRROL CT-1K; manufactured by Sanyo Chemical Indsutries, Ltd., product name: SANMORIN OT-70S)
Alkyl (C12-16) benzyldimethylammonium chloride (manufactured by Kao Corporation, product name: SANISOL C)
Lauric acid amidopropyl dimethylamine oxide (manufactured by KAWAKEN Fine Chemicals Co., Ltd., product name: SOFTAZOLINE LAO-C)
Sodium polyoxyethylene lauryl ether sulfate (manufactured by Kao Corporation, product name: EMAL 270J)
Polyoxyethylene (9) lauryl ether (manufactured by Kao Corporation, product name: EMULGEN 109P)

### (Film-Formable Polymer)

N-Methacryloyloxyethyl N,N-dimethylammonium-α-N-methylcarboxybetaine/methacrylic acid alkyl ester copolymer (manufactured by Mitsubishi Chemical Corporation, product name: YUKAFORMER R205S)

### Examples 1 to 10 and Comparative Examples 1 to 4 (Preparation and Evaluation of Flying Pest Exterminating Composition)

Each component used in the flying pest exterminating composition was used to prepare a flying pest exterminating composition having the composition shown in Tables 1 and 2. In the preparation, each component was dissolved by a stirrer so as to be a homogeneous system. The amount described in each table is an amount of the active ingredient (% by mass) of each component. Further, the amount of the surfactant (A) described in each table is an amount of a dissociation type as described above. In addition, a nonionic surfactant which is not dissociated in the composition is a blending amount. In addition, the amounts of alkyl (C12-16) benzyldimethylammonium chloride, lauric acid amidopropyl dimethylamine oxide, and lauryl trimethylammonium chloride were expressed as a blending amount instead of an amount of a dissociation type.

Using the obtained flying pest exterminating composition, various evaluations were performed by the above-mentioned methods. The evaluation results are shown in Tables 1 and 2, respectively.

TABLE 1

| | | | | | | | | | Comparative | |
|---|---|---|---|---|---|---|---|---|---|---|
| | | | Example | | | | | | Example | |
| | | | 1 | 2 | 3 | 4 | 5 | 6 | 1 | 2 |
| Composition | Surfactant | 2-Ethylhexyl glyceryl ether | | | 0.05 | | 0.2 | | | |
| blend | (A1) | (PENETOL GE-EH) | | | | | | | | |
| (% by mass) | Surfactant | Sodium dioctyl sulfosuccinate | 0.47 | 0.28 | 0.19 | | | | 0.19 | |
| | (A2) | (AIRROL CT-1K; SANMORIN OT-70S) | | | | | | | | |
| | | Alkyl (C12-16) benzyldimethylammonium | | | | 0.25 | | | | |
| | | chloride (SANISOL C) | | | | | | | | |
| | | Lauric acid amidopropyl dimethylamine | | | | | 0.50 | | | |
| | | oxide (SOFTAZOLINE LAO-C) | | | | | | | | |
| | | Sodium polyoxyethylene lauryl ether | | | | | | 0.47 | | 0.47 |
| | | sulfate (EMAL 270J) | | | | | | | | |
| | Film- | N-Methacryloyloxyethyl N,N- | | | | | | | | 0.5 |
| | formable | dimethylammonium-α-N- | | | | | | | | |
| | polymer | methylcarboxybetaine/methacrylic acid | | | | | | | | |
| | | alkyl ester copolymer | | | | | | | | |
| | | (YUKAFORMER R205S) | | | | | | | | |

| | | | | | | | | | |
|---|---|---|---|---|---|---|---|---|---|
| | Water | 99.5 | 99.7 | 99.76 | 99.75 | 99.3 | 99.5 | 99.8 | 99.0 |
| Evaluation | Volume proportion of sprayed product having particle | 78.83 | 89.7 | 80.1 | 79.7 | 80 | 85.9 | 89.9 | 76.7 |
| results | diameter of 310 μm or less [%] | | | | | | | | |
| | Volume proportion of sprayed product having particle | 6.21 | 0.13 | 4.18 | 6.79 | 5.79 | 1.87 | 0.00 | 4.88 |
| | diameter of 354 μm or more and 773 μm or less [%] | | | | | | | | |
| | Volume proportion of sprayed droplets having particle | 3.25 | 3.99 | 3.98 | 2.41 | 2.77 | 3.40 | 6.06 | 4.92 |
| | diameter of 1483 μm or more and 1926 μm or less [%] | | | | | | | | |
| | Reaching rate of sprayed product to 30 cm ahead [%] | 58.3 | 48.5 | 58.2 | 55.2 | 51.1 | 47.3 | 46.0 | 44.8 |

TABLE 2

| | | | | | | | Comparative | |
|---|---|---|---|---|---|---|---|---|
| | | | Example | | | | Example | |
| | | | 7 | 8 | 9 | 10 | 3 | 4 |
| Composition | Surfactant | 2-Ethylhexyl glyceryl ether | 0.40 | | | | | |
| blend (% by | (A1) | (PENETOL GE-EH) | | | | | | |
| mass) | | Sodium N-lauroyl-N-methyltaurine | | 0.37 | | | | |
| | | (NIKKOL LMT-P) | | | | | | |
| | | Sodium dodecylsulfate (EMAL O) | | | 0.37 | | | |
| | | Lauryl trimethylammonium chloride | | | | 0.40 | | |
| | Surfactant | Polyoxyethylene (9) lauryl ether | 0.5 | 0.5 | 0.5 | 0.5 | 0.5 | 0.2 |
| | (A2) | (EMULGEN 109P) | | | | | | |

| | | | | | | | |
|---|---|---|---|---|---|---|---|
| | Water | 99.1 | 99.1 | 99.1 | 99.1 | 99.5 | 99.8 |
| Evaluation | Volume proportion of sprayed product having particle | 87.28 | 82.1 | 77.3 | 72 | 89.4 | 89.7 |
| results | diameter of 310 μm or less [%] | | | | | | |
| | Volume proportion of sprayed product having particle | 2.97 | 5.19 | 7.68 | 9.29 | 0.00 | 0.00 |
| | diameter of 354 μm or more and 773 μm or less [%] | | | | | | |
| | Volume proportion of sprayed droplets having particle | 2.60 | 2.99 | 3.07 | 3.32 | 10.6 | 10.3 |
| | diameter of 1483 μm or more and 1926 μm or less [%] | | | | | | |
| | Reaching rate of sprayed product to 30 cm ahead [%] | 48.5 | 53.8 | 49.2 | 58.0 | 45.1 | 45.4 |

From Tables 1 and 2, it is understood that according to the flying pest exterminating spray and the flying pest exterminating composition of the present invention, the sprayed product can efficiently reach flying pests, and the effect of reducing the flying ability of mosquitoes, which are flying pests, is excellent.

### INDUSTRIAL APPLICABILITY

According to the present invention, it is possible to obtain a flying pest exterminating spray, which has high straightness when a composition is sprayed from a spray, can allow a flying pest exterminating composition to efficiently reach flying pests, and can improve the extermination effect.

What is claimed is:

1. A flying pest exterminating spray, comprising a trigger spray type spray container and a flying pest exterminating composition filled in the trigger spray type spray container, wherein the flying pest exterminating composition contains a surfactant (A) and water, and in the volume particle size distribution of a sprayed product of the flying pest exterminating spray measured at a position of 30 cm in terms of a horizontal distance from an injection port of the trigger spray type spray container, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

2. The flying pest exterminating spray according to claim 1, wherein the content of a film-formable polymer in the flying pest exterminating composition is less than 0.5% by mass.

3. The flying pest exterminating spray according to claim 1, wherein the surfactant (A) comprises a surfactant (A2) other than at least one surfactant (A1) selected from 2-ethylhexyl glyceryl ether, N-lauroyl-N-methyltaurine salt, dodecylsulfate, and lauryl trimethylammonium salt.

4. The flying pest exterminating spray according to claim 3, wherein the surfactant (A2) is at least one selected from a cationic surfactant, an anionic surfactant, an amphoteric surfactant, and a nonionic surfactant; the cationic surfactant contains at least one selected from a quaternary ammonium salt having an alkyl group having 10 or more and 18 or less carbon atoms; the anionic surfactant contains at least one selected from a salt of a mono- or di-ester of an aliphatic alcohol having 5 or more and 18 or less carbon atoms and sulfosuccinic acid, an alkyl or alkenyl sulfate ester salt having an alkyl group having 10 or more and 18 or less carbon atoms, a polyoxyalkylene alkyl ether sulfate ester salt, an N-acylamino acid salt, an N-acyl-N-methylamino acid salt, a linear alkylbenzenesulfonate, and a fatty acid salt; the amphoteric surfactant contains at least one selected from an alkylamine oxide having an alkyl group having 10 or more and 18 or less carbon atoms and an alkylbetaine having an alkyl group having 10 or more and 18 or less carbon atoms; and the nonionic surfactant contains at least one selected from a polyoxyalkylene alkyl ether, a polyoxyalkylene sorbitan fatty acid ester, an alkyl glucoside, an alkyl glyceryl ether, a polyglycerin fatty acid ester, a polyoxyethylene hardened castor oil, a polyoxyethylene alkylamine, and a polyoxyethylene modified silicone.

5. The flying pest exterminating spray according to claim 3, wherein the surfactant (A2) is at least one selected from a cationic surfactant, an anionic surfactant, and an amphoteric surfactant, the content of the surfactant (A1) is 0% by mass or more and 1.0% by mass or less, and the content of the surfactant (A2) is more than 0.2% by mass and 2.0% by mass or less.

6. The flying pest exterminating spray according to claim 3, wherein the surfactant (A2) is at least one selected from a cationic surfactant, an anionic surfactant, and an amphoteric surfactant, the content of the surfactant (A1) is 0.01% by mass or more and 1.0% by mass or less, and the content of the surfactant (A2) is 0.1% by mass or more and 2.0% by mass or less.

7. The flying pest exterminating spray according to claim 3, wherein the surfactant (A2) is a nonionic surfactant, the content of the surfactant (A1) is 0.01% by mass or more and 1.0% by mass or less, and the content of the surfactant (A2) is 0.1% by mass or more and 2.0% by mass or less.

8. The flying pest exterminating spray according to claim 1, wherein the content of the water in the flying pest exterminating composition is 80% by mass or more and 99.89% by mass or less.

9. The flying pest exterminating spray according to claim 1, wherein the trigger spray type spray container has an injection orifice diameter of 0.1 mm or more and 1.5 mm or less.

10. A flying pest exterminating composition which is used by spraying on flying pests, comprising a surfactant (A) and water, and in the volume particle size distribution of a sprayed product of the flying pest exterminating composition measured at a position of 30 cm in terms of a horizontal distance from an injection port of a spray container filled with the flying pest exterminating composition, the proportion of the sprayed product having a particle diameter of 310 μm or less is 70% by volume or more and 95% by volume or less, the proportion of the sprayed product having a particle diameter of 354 μm or more and 773 μm or less is 0.05% by volume or more, and the proportion of the sprayed product having a particle diameter of 1483 μm or more and 1926 μm or less is 4.90% by volume or less.

11. The flying pest exterminating composition according to claim 10, wherein the content of a film-formable polymer is less than 0.5% by mass.

12. The flying pest exterminating composition according to claim 10, wherein the content of the water is 80% by mass or more and 99.89% by mass or less.

13. The flying pest exterminating spray according to claim 10, wherein the surfactant (A) comprises a surfactant (A2) other than at least one surfactant (A1) selected from 2-ethylhexyl glyceryl ether, N-lauroyl-N-methyltaurine salt, dodecylsulfate, and lauryl trimethylammonium salt.

14. The flying pest exterminating spray according to claim 13, wherein the surfactant (A2) is at least one selected from a cationic surfactant, an anionic surfactant, an amphoteric surfactant, and a nonionic surfactant; the cationic surfactant contains at least one selected from a quaternary ammonium salt having an alkyl group having 10 or more and 18 or less carbon atoms; the anionic surfactant contains at least one selected from a salt of a mono- or di-ester of an aliphatic alcohol having 5 or more and 18 or less carbon atoms and sulfosuccinic acid, an alkyl or alkenyl sulfate ester salt having an alkyl group having 10 or more and 18 or less carbon atoms, a polyoxyalkylene alkyl ether sulfate ester salt, an N-acylamino acid salt, an N-acyl-N-methylamino acid salt, a linear alkylbenzenesulfonate, and a fatty acid salt; the amphoteric surfactant contains at least one selected from an alkylamine oxide having an alkyl group having 10 or more and 18 or less carbon atoms and an alkylbetaine having an alkyl group having 10 or more and 18 or less carbon atoms; and the nonionic surfactant contains at least one selected from a polyoxyalkylene alkyl ether, a polyoxyalkylene sorbitan fatty acid ester, an alkyl glucoside, an alkyl glyceryl ether, a polyglycerin fatty acid ester, a polyoxyethylene hardened castor oil, a polyoxyethylene alkylamine, and a polyoxyethylene modified silicone.

15. The flying pest exterminating spray according to claim 13, wherein the surfactant (A2) is at least one selected from a cationic surfactant, an anionic surfactant, and an amphoteric surfactant, the content of the surfactant (A1) is 0% by mass or more and 1.0% by mass or less, and the content of the surfactant (A2) is more than 0.2% by mass and 2.0% by mass or less.

16. The flying pest exterminating spray according to claim 13, wherein the surfactant (A2) is at least one selected from a cationic surfactant, an anionic surfactant, and an amphoteric surfactant, the content of the surfactant (A1) is 0.01% by mass or more and 1.0% by mass or less, and the content of the surfactant (A2) is 0.1% by mass or more and 2.0% by mass or less.

17. The flying pest exterminating spray according to claim 13, wherein the surfactant (A2) is a nonionic surfactant, the content of the surfactant (A1) is 0.01% by mass or more and 1.0% by mass or less, and the content of the surfactant (A2) is 0.1% by mass or more and 2.0% by mass or less.
